(19) United States
(12) Patent Application Publication
(10) Pub. No.: US 2025/0071135 A1
(43) Pub. Date: Feb. 27, 2025

(54) DETECTING VULNERABILITIES BY SEEDING A COMPUTING RESOURCE WITH MONITORED SCRIPTS

(71) Applicant: Google LLC, Mountain View, CA (US)

(72) Inventors: Jared Loyd Wood, West Bothel, WA (US); Paul Arvind Mehta, Mission Viejo, CA (US)

(21) Appl. No.: 18/453,593

(22) Filed: Aug. 22, 2023

(51) Int. Cl. H04L 9/40

(52) U.S. Cl. CPC H04L 63/1433; H04L 63/1416

(57) ABSTRACT

Systems and methods for detecting intrusive activity are provided. One or more scripts are generated. Each script is directed to perform an intrusive activity. The one or more scripts are submitted to a target resource. Responsive to receiving an indication of an execution of a script of the one or more scripts at the target resource, the target resource is determined to be vulnerable to the intrusive activity. An event associating the target resource with the intrusive activity is logged in the detection log.

### TECHNICAL FIELD

Aspects and implementations of the present disclosure relate to computer security, and in particular to detecting vulnerabilities by seeding a computing resource with monitored scripts.

### BACKGROUND

Computing resources such as data centers, computing platforms, and applications may be susceptible to intrusive activity (e.g., data breaches, denial-of-service (DoS) attacks, ransomware, malware, network-based attacks). Intrusive activity can pose severe risks to the integrity and confidentiality of sensitive information, financial assets, and essential services. Intrusive activity can lead to interruption or inefficient operation of computing resources, which can be problematic for owners and operators of computing resources. In extreme cases, intrusive activity can damage computing resources or data stored thereon, potentially causing substantial financial loss and other losses and liabilities for the owners and operators of computing resources.

Identifying and mitigating vulnerabilities in a timely and proactive manner are crucial steps in maintaining the resilience and security of modern computing environments. Security platforms can have intrusive activity notification mechanisms in place that alert clients when intrusive activity is detected. The detection process in conventional security platforms is often a manual and time-consuming process for security professionals, which can result in human errors and can strain the human resources of security teams, thereby decreasing the overall effectiveness of and threat coverage of the security platform.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In some implementations, a system and method are disclosed for detecting vulnerabilities by seeding a computing resource with monitored scripts. In an implementation, a method includes generating one or more scripts that are each directed to perform an intrusive activity. The method further includes submitting the one or more scripts to a target resource. The method further includes, responsive to receiving an indication of an execution of a script of the one or more scripts at the target resource, determining that the target resource is vulnerable to the intrusive activity. The method further includes logging, in a detection log, an event associating the target resource with the intrusive activity. In some implementations, the method further includes providing a notification to a user device indicating the target resource that is vulnerable to the intrusive activity.

In some implementations, the one or more scripts are transferred from the target resource to a second target resource. In some implementations, the method further includes, responsive to receiving a second indication of a second execution of the script of the one or more scripts at the second target resource, determining that the second target resource is vulnerable to the intrusive activity.

In some implementations, responsive to receiving the indication of the execution of the script, the method further includes comparing the indication to known benign activity. The method further includes, responsive to determining, based on the comparing, that the indication is benign, updating the event in the detection log to indicate that the intrusive activity is benign. In some implementations, the method further includes updating the one or more scripts by removing the script corresponding to the intrusive activity that is benign. In some implementations, the method further includes generating an additional script comprising an instruction to terminate the execution of the script corresponding to the intrusive activity that is benign at the target resource. In some implementations, the method further includes submitting the additional script to the target resource.

An aspect of the disclosure provides a system including a memory device and a processing device communicatively coupled to the memory device. The processing device performs operations that include generating one or more scripts that are each directed to perform an intrusive activity. The processing device performs operations further including submitting the one or more scripts to a target resource. The processing device performs operations further including, responsive to receiving an indication of an execution of a script of the one or more scripts at the target resource, determining that the target resource is vulnerable to the intrusive activity. The processing device performs operations further including logging, in a detection log, an event associating the target resource with the intrusive activity. In some implementations, the processing device performs operations further including providing a notification to a user device indicating the target resource that is vulnerable to the intrusive activity.

In some implementations, the one or more scripts are transferred from the target resource to a second target resource. In some implementations, the processing device performs operations further including, responsive to receiving a second indication of a second execution of the script of the one or more scripts at the second target resource, determining that the second target resource is vulnerable to the intrusive activity.

In some implementations, responsive to receiving the indication of the execution of the script, the processing device performs operations further including comparing the indication to known benign activity. The processing device performs operations further including, responsive to determining, based on the comparing, that the indication is benign, updating the event in the detection log to indicate that the intrusive activity is benign. In some implementations, the processing device performs operations further including updating the one or more scripts by removing the script corresponding to the intrusive activity that is benign.

In some implementations, the processing device performs operations further including generating an additional script that includes an instruction to terminate the execution of the script corresponding to the intrusive activity that is benign from the target resource. The processing device performs further operations including submitting the additional script to the target resource.

An aspect of the disclosure provides a computer-readable storage medium (which may be a non-transitory computer-readable storage medium, although the disclosure is not limited to that) stores instructions which, when executed, cause a processing device to perform operations including generating one or more scripts that are each directed to perform an intrusive activity. The processing device performs operations further including submitting the one or more scripts to a target resource. The processing device performs operations further including, responsive to receiving an indication of an execution of a script of the one or more scripts at the target resource, determining that the target resource is vulnerable to the intrusive activity. The processing device performs operations further including logging an event associating the target resource with the intrusive activity in a detection log. In some implementations, the processing device performs operations further including providing a notification to a user device indicating the target resource that is vulnerable to the intrusive activity.

In some implementations, the one or more scripts are transferred from the target resource to a second target resource. In some implementations, the processing device performs operations further including, responsive to receiving a second indication of a second execution of the script of the one or more scripts at the second target resource, determining that the second target resource is vulnerable to the intrusive activity.

In some implementations, responsive to receiving the indication of the execution of the script, the processing device performs operations further including comparing the indication to known benign activity. The processing device performs operations further including, responsive to determining, based on the comparing, that the indication is benign, updating the event in the detection log to indicate that the intrusive activity is benign. In some implementations, the processing device performs operations further including updating the one or more scripts by removing the script corresponding to the intrusive activity that is benign.

In some implementations, the processing device performs operations further including generating an additional script comprising an instruction to terminate the execution of the script corresponding to the intrusive activity that is benign at the target resource. The processing device performs operations further including submitting the additional script to the target resource.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with at least one embodiment of the present disclosure.

FIG. 2 is a flow diagram of an example method for providing a proactive vulnerability detection system, in accordance with at least one embodiment of the present disclosure.

FIG. 3 is a diagram illustrating an implementation of a method executed for detecting a vulnerability in a computing resource using monitored scripts, in accordance with at least one embodiment of the present disclosure.

FIG. 4 is a block diagram illustrating an exemplary computer system, in accordance with at least one embodiment of the present disclosure.

### DETAILED DESCRIPTION

Aspects of the present disclosure relate to detecting intrusive activity in a computing resource by seeding the resource with monitored scripts. Computing resources can include, for example, servers, data centers, and cloud computing resources (including physical machines and virtual resources such as virtual machines and containers). Various computing resources can be susceptible to intrusive activity. Examples of intrusive activity include installation or operation of malware (e.g., malicious software), accessing or attempting to access computing resources without permission or authorization, modifying or exfiltrating data stored on computing resources without permission or authorization, exhausting computing resources (e.g., a denial-of-service attack), and other forms of unwanted activity. Intrusive activity is often problematic for owners and operators of computing resources because the intrusive activity can lead to interruption or inefficient operation of computing resources, or in extreme cases, substantial financial loss and liabilities.

A security platform can provide services for detecting intrusive activity with respect to computing resources, through various cybersecurity measures. These methods can identify suspicious or unauthorized actions that have occurred within a computing resource. For example, a security platform can receive data from computing resources, and analyze the data for signs of intrusive activity. The security platform can associate patterns in the data with different types of intrusive activity, and upon detecting intrusive activity, the platform can issue an alert to the computing resources (e.g., via an API) or the owners and operators of the computing resource (e.g., via email). The intrusive activity can then be investigated, e.g., by security personnel, who can take mitigating steps if needed.

One example of intrusive activity that can be particularly problematic is cross-site scripting (XSS) vulnerability. XSS is a type of security vulnerability typically found in web applications. Using XSS, attackers can inject client-side scripts into web pages viewed by other users, which can result in unauthorized access to sensitive data and functionality, for example. XSS vulnerabilities can lead to a variety of issues, including identity theft, session hijacking, and defacement of websites. Additionally, XSS can be blind, meaning that the injected script is not executed immediately, but rather is stored for later use, often in a different part of the application. For example, an attacker can inject malicious scripts into a website, and the scripts are stored and executed at a later date when a different user and/or administrator accesses that part of the application.

In conventional security platforms, detection and mitigation of intrusive activity is often a manual and time-consuming process. For example, a skilled security professional (e.g., a security researcher) can expend considerable time manually analyzing data, such as time series event logs or malware binary samples, to identify patterns and commonalities that can be used to detect an instance or class of intrusive activity. The security professional can then determine whether data received at the security platform poses a threat to the computing resource. Furthermore, conventional security platforms receive an alert indicative of potential intrusive activity only after the potential intrusive activity has begun execution. Consequently, the computing resource on which the intrusive activity has begun execution can already be compromised. As a result of the intrusive activity, at least some of the computing resource can be unrecoverable.

Aspects of the present disclosure address the above-noted and other deficiencies by providing a proactive vulnerability detection system that can determine whether a computing resource is vulnerable to intrusive activity before any malicious activity happens on the computing resource. Security platforms and other systems or services utilizing the techniques described herein can seed a target computing resource with monitored scripts that mimic known intrusive activity techniques, such as XSS or blind XSS. The scripts are designed to reveal vulnerabilities within computing resources. Thus, the scripts are designed to execute under the same (or similar) conditions as known malicious intrusive activity techniques. Once one of the monitored scripts has initiated execution, the script can send a signal to a listener service. For example, the listener service can be operating within the security platform. In some embodiments, the signal can be a system call included in the script. In some embodiments, the signal can be a notification, for example, transmitted via an API. The signal can include an indication of which script has been activated, on which computing resource the script has been activated, and/or the lineage of the script. The lineage can facilitate tracking of the path of the script. For example, while a script can be submitted to a target computing resource, that target computing resource can send the script to other computing resources. As such, the script can mimic an intrusive activity that is designed to self-replicate across multiple computing resources, or that is designed to be routed to other users (e.g., cross-site scripting). Once the listener service receives a signal from one of the scripts, the listener service can identify the computing resource that is vulnerable to the script that generated the signal, and can identify the intrusive activity to which the computing resource is vulnerable. Thus, the vulnerability can be detected by the monitored scripts that mimic intrusive activity, prior to the computing resource being exposed to intrusive activity injected by an attacker.

Aspects of the present disclosure provide technical advantages over previous solutions. Aspects of the present disclosure can provide improved vulnerability detection by proactively identifying computing resources that can be vulnerable to intrusive activity. Embodiments described herein can provide improved accuracy and efficiency when detecting intrusive activity with respect to computing resources. The monitored scripts submitted to target computing resources provide improved threat coverage by identifying vulnerable resources before they are infected with malicious intrusive activity, thus avoiding the problematic consequences of the malicious intrusive activity. By identifying the computing resources vulnerable to intrusive activity before malicious intrusive activity happens on the resource, fewer computing resources are needed to remedy the vulnerability than would otherwise be needed to remedy the malicious activity that has already happens. Thus, security platforms that utilize techniques described herein can be more efficient than conventional security platforms. Furthermore, as soon as a signal is received identifying a computing resource that is vulnerable to a particular intrusive activity, security professionals can begin the remediation process to prevent malicious intrusive activity from executing on the identified computing resource. Thus, security platforms using the techniques described herein can experience reduced operating costs and improved latency and throughput, which may benefit clients and increase trust in the security platform.

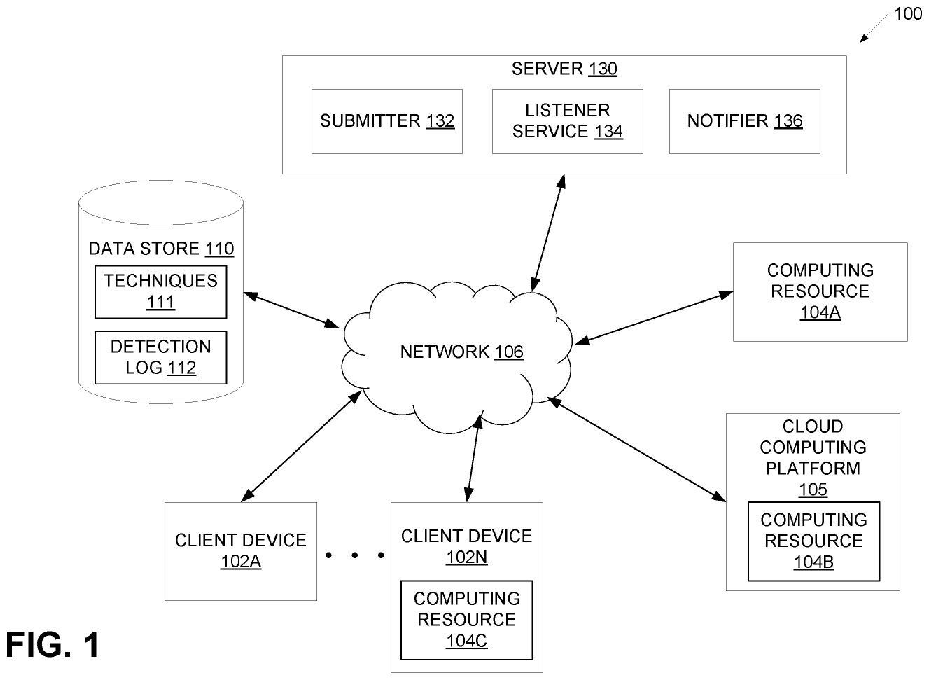

FIG. 1 illustrates an example system architecture 100, in accordance with at least one embodiment of the present disclosure. The system architecture 100 includes client devices 102A-N, computing resources 104A-C, cloud computing platform 105, a data store 110, and/or a server 130, each connected to a network 106. Note that while three computing resources 104A-C are illustrated in FIG. 1, system 100 is not limited to three computing resources 104A-C, and can include fewer or additional computing resources 104A-C. Network 106 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

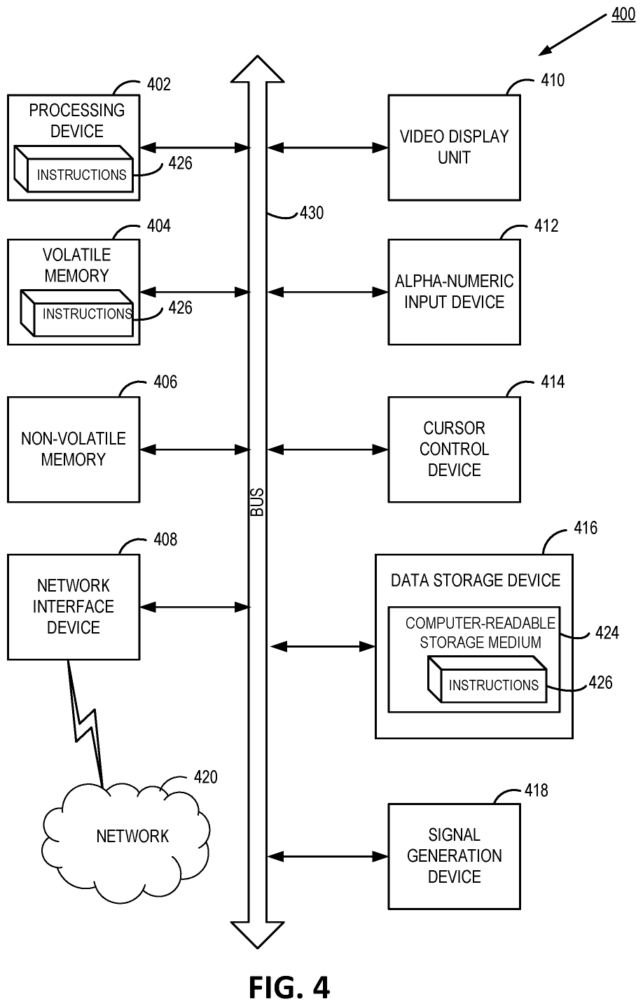

Client devices 102A-N can each include computing devices such as personal computers (PCs), laptops, mobile phones, smart phones, tablet computers, netbook computers, network-connected televisions, digital assistants, servers, networking equipment, or any other computing devices. FIG. 4 illustrates an example architecture of a client device 102A-N. In some embodiments, client devices 102A-N can also be referred to as “user devices.” Client devices 102A-N can be used by users such as security professionals, owners and operators of computing resources 104A-C, and/or users accessing computing resources 104A-C. Client devices 102A-N can host a computing resource 104C, and/or can access a computing resource 104A-C. Computing resources 104A-C can be vulnerable to malicious intrusive activity (e.g., may not be capable of resisting to an occurrence of an activity that can jeopardize security of a respective resource or one or more other resources in the system 100).

In some embodiments, computing resources 104A-C can include one or more processing devices, volatile and non-volatile memory, data stored, one or more input/output peripherals such as network interfaces. FIG. 4 illustrates an example architecture of computing resources. In some embodiments, computing resources 104A-C can be singular devices such as smartphones, tablets, laptops, desktops, workstations, edge devices, embedded devices, servers, network appliances, security appliances, etc. In some embodiments, computing resources 104A-C can comprise multiple devices of similar or varying architecture such as computing clusters, data centers, co-located servers, enterprise networks, geographically disparate devices connected via virtual private networks (VPNs), etc. In some embodiments, computing resources 104A-C can comprise hardware devices such as those just described, virtual resources such as virtual machines (VMs) and containerized applications, or a combination of hardware and virtual resources. In some embodiments, computing resources can be associated with one or more entities. For example, an entity can own or lease hardware devices such as a server or a data center. In another example, a client entity can lease virtual resources (e.g., a VM) from a provider entity. The provider entity can provision the virtual resources (along with virtual resources associated with other client entities) on hardware devices that the provider entity owns or leases itself. In some embodiments, computing resources 104A-C can be accessible via an application, e.g., a web application.

In some embodiments, cloud computing platform 105 can enable users (e.g., of client devices 102A-N) to access and utilize various computing resources (e.g., computing resources 104A-C), e.g., via network 106. For example, a provider entity associated with cloud computing platform 105 can offer to lease computing resources 104A-C, such as hardware devices, virtual machines, etc. In some embodiments, computing resources 104A-C can be distributed across multiple hardware devices (e.g., within a data center or across disparate geographical locations) and can be communicatively connected via internal networks (not depicted), external networks such as network 106, or a combination thereof. The provider entity can include various users (e.g., security researchers and other professionals/employees) to manage the computing resources 104B of cloud computing platform 105. In some embodiments, submitter 132, listener service 134, and/or notifier 136 (and/or parts thereof) can be executed on cloud computing platform 105.

In some embodiments, data store 110 is a persistent storage that is capable of storing data as well as data structures to tag, organize, and index the data. Data store 110 can be hosted by one or more storage devices, such as main memory, magnetic or optical storage-based disks, tapes or hard drives, NAS, SAN, and so forth. In some embodiments, data store 110 can be a network-attacked file server, while in other embodiments data store 110 can be some other type of persistent storage such as an object-oriented database, a relational database, and so forth, that can be hosted on or can be a component of server 130 or one or more different machines (e.g., via network 106). In some embodiments, data store 110 can be provided by a third-party service such as a cloud platform provider. In some embodiments, the data store 110 can store techniques 111 and/or a detection log 112.

Techniques 111 can store known intrusive activity techniques. In some embodiments, known intrusive activity techniques can be gathered and stored by security professionals. Techniques 111 can reflect certain intrusive activity, such as data exfiltration techniques, cross-site scripting, blind cross-site scripting, malware, denial-of-service attacks, ransomware, or other known malicious or intrusive activities. For example, techniques 111 can store conditions that trigger the execution of intrusive activity, such as malicious code. Malicious code can, for example, modify functionality to reroute applications, take over an application, monitor applications, exfiltrate data, destroy data, self-replicate across multiple computing resources, etc. Thus, each technique stored in techniques 111 can include instructions that mimic the execution of a known intrusive activity. For example, techniques 111 can include multiple records, and each record can store a set of instructions that mimic intrusive techniques. For example, one set of instructions can activate a known data exfiltration activity, while another set of instructions can activate a known blind cross-site scripting activity. Techniques 111 can be used to generate scripts that activate (or begin executing) under the same conditions as the intrusive activity corresponding to the technique.

Detection log 112 can be a data structure (e.g., one or more files, database tables, etc.) storing data (e.g., events) that associate computing resources (e.g., computing resources 104A-C) with intrusive activity. Each event in detection log 112 can correspond to a signal received from a script, e.g., by listener service 134. As an illustrative example, detection log 112 can be a table of multiple records, and each record in the table can store information relating to an event. In some embodiments, the data stored in the detection log 112 can be a chronological record of activities that occurred (e.g., of signals received). The detection log 112 can store, for example, an event description (e.g., identifying the script that sent the signal associated with the event), the source (e.g., identifying on which computing resource 104A-C the script was activated), a timestamp (e.g., the time the signal was received), event data and parameters (e.g., the time that the script was activated on the computing resource, the lineage of the script), and/or any other data related to the event. In some embodiments, the detection log 112 can be used by notifier 136 to send a notification to the user of the events that occurred relating to the scripts submitted by submitter 132. The notification can be sent to a user, e.g., a security professional. In some embodiments, the detection log 112 can be accessed by a user (e.g., a security professional), and/or by another component running within system 100, to identify vulnerable computing resources 104A-C (or other vulnerable computing resources).

In some embodiments, server 130 can be a rackmount server, a router computer, a personal computer, a portable digital assistant, a mobile phone, a laptop computer, a tablet computer, a netbook, a desktop computer, a virtual machine, etc., or any combination of the above. Server 130 can include a submitter 132, a listener service 134, and/or a notifier 136. In some embodiments, submitter 132, listener service 134, and/or notifier 136 can be part of a security platform (not depicted).

In some embodiments, submitter 132 can generate one or more scripts that mimic malicious intrusive activity. Submitter 132 can access techniques 111, and can generate scripts that mimic the intrusive activity stored at techniques 111. For example, the techniques 111 can include instructions that correspond to known intrusive techniques. The instructions can include, for example, code to behave the same way as scripting attacks (e.g., including blind cross-site scripting), backdoor attacks, worms, spyware, etc. The instructions stored in techniques 111 can provide the conditions under which known intrusive activity is initiated. The scripts generated by submitter 132 can include the instructions that initiate known intrusive activity techniques. Rather than performing the intrusive activity, however, once initiated, the scripts can send a signal to listener service 134.

The submitter 132 can submit the generated scripts to computing resources 104A-C. In some embodiments, submitter 132 can generate a payload the includes the one or more generated scripts, and can submit the payload to computing resources 104A-C (or to a subset of computing resources 104A-C). Submitting the scripts to computing resources 104A-C can include injecting the scripts to computing resources 104A-C, installing the scripts on computing resources 104A-C, submitting the scripts to computing resources 104A-C via a user interface, or any other method that results in the scripts being sent to and/or stored on computing resources 104A-C. In some embodiments, submitter 132 can submit the one or more scripts to a computing resource 104A-C that is identified as a system under test. A system under test can be one or more computing resources 104A-C that are identified as resources that are to be tested for vulnerabilities, e.g., as a part of a detection campaign.

In some embodiments, the submitter 132 can submit the one or more scripts to known computing resources (e.g., computing resources 104A-B), and the known computing resources can transfer some (or all) of the one or more scripts to other computing resources (e.g., computing resources 104C). For example, server 130 may not have access to client device 102N, and may not be aware that computing resource 104C is executing on client device 102N. However, computing resource 104A and/or 104B can send the script(s) to computing resource 104C. For example, one of the scripts can mimic cross-site scripting, which can include code that is routed to other user(s), e.g., by the browser to which it was submitted. Thus, while the script(s) can be submitted by submitter 132 to known computing resources (e.g., 104A,B), the script(s) can be activated by another computing resource (e.g., 104C). Each script can include an instruction to send a signal to listener service 134 upon execution. The signal can be, for example, a notification, a data packet, a message, or some other signal that a script has been activated.

Listener service 134 can be a component that is designed to monitor and receive incoming signals (e.g., messages or events) from various sources (e.g., from computing resources 104A-C). In some embodiments, listener service 134 can receive signals from the one or more scripts executed on computing resources 104A-C. Upon receiving a signal from a computing resource 104A-C, the listener service 134 can take appropriate action. For example, the listener service 134 can log, in detection log 112, an event associating the computing resource 104A-C that sent the signal with the script that was activated on the computing resource 104A-C.

In some embodiments, the listener service 134 can identify whether a signal is associated with benign activity. For example, benign activity can be activity that, when the script was generated, was considered intrusive, but has since been identified as no longer intrusive, or harmless. Thus, signals received from such a script can be safely ignored. As another example, multiple scripts can be submitted to the same computing resource 104A-C and can result in script resonance (e.g., a first script can activate a second script, which in turn activates the first script, and back and forth). As another example, benign activity can be activity that was submitted as part of an expired detection campaign. A detection campaign can submit multiple scripts as part of a payload, and the detected vulnerabilities can be grouped together as part of the campaign. In some instances, the detection campaign can expire, and thus the scripts submitted as part of the detection campaign may no longer be considered intrusive. The signals received from scripts in the payload associated with a terminated (or expired) detection campaign can be identified as benign.

In some embodiments, to determine if a signal is benign, the listener service 134 can compare the signal to a list of known benign activity. That is, the listener service 134 can maintain a list of benign activities. In some embodiments, the list can be stored in data store 110. As an example, the list can include identifiers identifying scripts which are considered benign, e.g., for any of the reasons described above (or for another reason not described here). As another example, the list can include identifiers identifying particular signals which are considered benign. The listener service 134 can then compare the received signal (which can include identifiers identifying the script and/or the signal) to the list of known benign activity to determine whether the received signal is benign.

In some embodiments, the listener service 134 can terminate or disable a script running on computing resource 104A-C. For example, the script can include a parameter that, if received, can terminate, disable, and/or prevent execution of the script. This can be useful in the event that a script produces resonant signals, or if the script is part of a detection campaign that has ended. Thus, the listener service 134 can send the particular parameter value to the script to prevent or halt execution. As another example, listener service 134 can generate a new script that includes instructions to prevent, disable, and/or terminate execution of a benign script. Listener service 134 can submit the new script to computing resources 104A-C (or, listener service 134 can send an instruction to submitter 132 to submit the new script). In some embodiments, the listener service 134 can remove a script from the one or more scripts submitted by submitter 132, so that it is no longer submitted to computing resources.

Upon determining that a signal is associated with benign activity, the listener service 134 can update the event logged in the detection log 112 to indicate that the event is associated with benign activity. In some embodiments, if the signal is benign, the listener service 134 can determine not to store an event in detection log 112 (or to delete the log in detection log 112) associating the script with the computing resource 104A-C. That is, the listener service 134 can determine to ignore signals that are identified as benign. If it is not benign, the listener service 134 can send a notification to the notifier 136.

In some embodiments, notifier 136 can send a notification. For example, notifier 136 can send a notification to a user of client device 102A-N. The notification can be a message, e.g., sent via email, and/or an alert, e.g., sent via an API. The notification can be another type of notification not listed here. The notification can include at least an indication of the script that activated and on which computing resource 104A-C the script activated. In some embodiments, notifier 136 can send a notification in response to listener service 134 logging and/or updating an event in detection log 112.

In situation in which the systems discussed here collects personal information about users, or may make use of personal information, the users may be provided with an opportunity to control whether listener service 134 and/or notifier 136 collects user information (e.g., information about a user's social network, social actions or activities, profession, network activity, virus scan results, a user's preferences, or a user's current location), or to control whether and/or how to receive content from the server 130 and/or computing resources 104A-C that may be more relevant to the user. In addition, certain data may be treated in one or more ways before it is stored or used, so that personally identifiable information is removed. For example, a user's identity may be treated so that no personally identifiable information may be determined for the user, or a user's geographic location may be generalized where location information is obtained (such as to a city, ZIP code, or state level), so that a particular location of a user cannot be determined. Thus, the user may have control over how information is collected about the user and used by computing resources 104A-C, client devices 104A-N, cloud computing platform 105, and/or server 130.

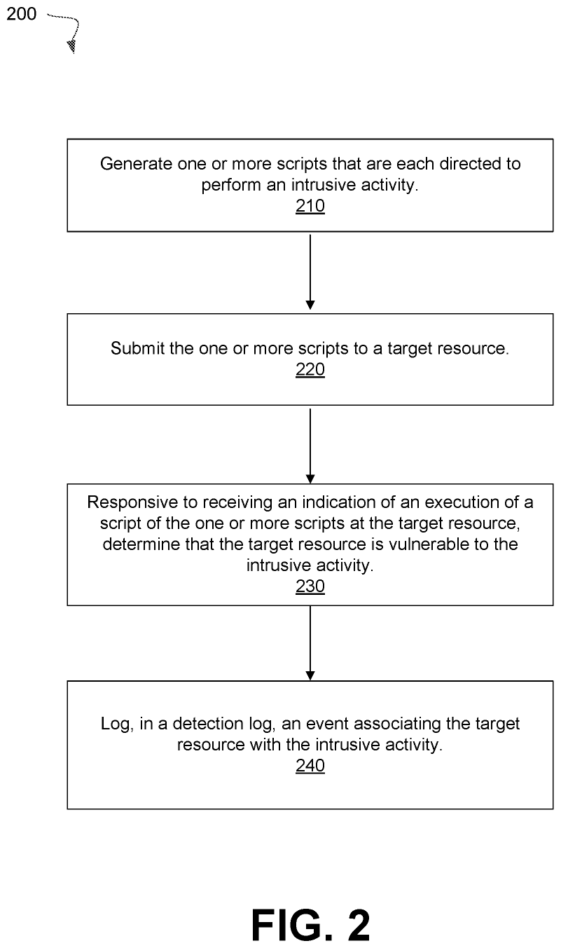

FIG. 2 is a flow diagram of an example method 200 for providing a proactive vulnerability detection system, e.g., by seeding a computing resource with monitored intrusive activity scripts, according to at least one embodiment. Method 200 can be performed by processing logic that can include hardware (circuitry, dedicated logic, etc.), software (e.g., instructions run on a processing device), or a combination thereof. In at least one implementation, some or all of the operations of method 200 can be performed by one or more components of server 130 of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states, e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-related device or storage media.

At block 210, processing logic generates one or more scripts that are each directed to perform an intrusive activity. The intrusive activity can correspond to known intrusive activity techniques. A script is a sequence of instructions that can be executed by a computing resource. For example, a script can be a text file that contains a sequence of commands or instructions that can be executed by an interpreter of a computing resource. The interpreter can read and execute the script line by line. Scripts can interact with other scripts and/or programs on a computing resource, or on separate computing resources. For example, a script can include an instruction to call other scripts and/or programs. In some embodiments, the one or more scripts can be generated based on user-provided input. The user input can include instructions to generate the one or more scripts to mimic known intrusive activity, such as techniques 111 of FIG. 1. In some embodiments, the one or more scripts can be user generated. Each script can mimic an intrusive activity by executing under the same (or similar) conditions that initiate execution of the intrusive activity. Once execution of the script is initiated, the script sends a signal (e.g., a notification) to a listener service. That is, the script can include an instruction to send a notification to a listener service (e.g., listener service 134 of FIG. 1). The notification can include information about the script, the computing resource on which the script executed, and/or other relevant information.

At block 220, processing logic submits the one or more scripts to a target resource. The target resource can be a computing resource (e.g., a physical machine under test, e.g., identified as a computing resource that is to be tested for vulnerabilities. In some embodiments, the target resource can be part of a detection campaign, and the one or more scripts can be submitted as a payload. Submitting the one or more scripts can include installing the scripts on the target resource, injecting the scripts to the computing resource, submitting the scripts to the target resource via a user interface, or some other method of submitting scripts to a resource.

In some implementations, some or all of the one or more scripts can be transferred from the target resource to a second target resource. For example, the script can mimic a technique that includes instructions to route to other resources that the target resource contacts. In some implementations, responsive to receiving a second indication of a second execution of the script of the one or more scripts at the second target resource, processing logic determines that the second target resource is vulnerable to the intrusive activity. In some embodiments, as the scripts are transferred from one resource to another, the script metadata can store identifiers that track the lineage of the script. For example, when a script is transferred from the target resource to the second target resource, the metadata can store identifiers of each of the target resources.

At block 230, responsive to receiving an indication of an execution of a script of the one or more scripts at the target resource, processing logic determines that the target resource is vulnerable to the intrusive activity.

In some embodiments, in response to receiving the indication of the execution of the script, the processing logic can compare the indication to known benign activity. For example, the indication can include a script and/or an intrusive activity identifier, and processing logic can compare the identifier to identifiers in the list of known benign activities. Responsive to determining, based on the comparison, that the indication is benign, processing logic updates the event in the detection to indicate that the intrusive activity is benign. For example, processing logic can add, to the event in the detection log, an indication (e.g., a flag) that the intrusive activity is benign. In some embodiments, processing logic can update the one or more scripts by removing the script corresponding to the intrusive activity that is benign. In some embodiments, processing logic can generate an additional script that includes an instruction to terminate the execution of the script corresponding to the intrusive activity that is benign. The additional script is submitted to the target resource.

At block 240, processing logic logs, in a detection log, an event associating the target resource with the intrusive activity. For example, processing logic logs an event in detection log 112 of FIG. 1. The event can include data identifying the script, the intrusive activity, the target resource, and/or any other relevant information. In some embodiments, processing logic can provide a notification to a user device (e.g., client device 102A) indicating the target resource that is vulnerable to the malicious activity.

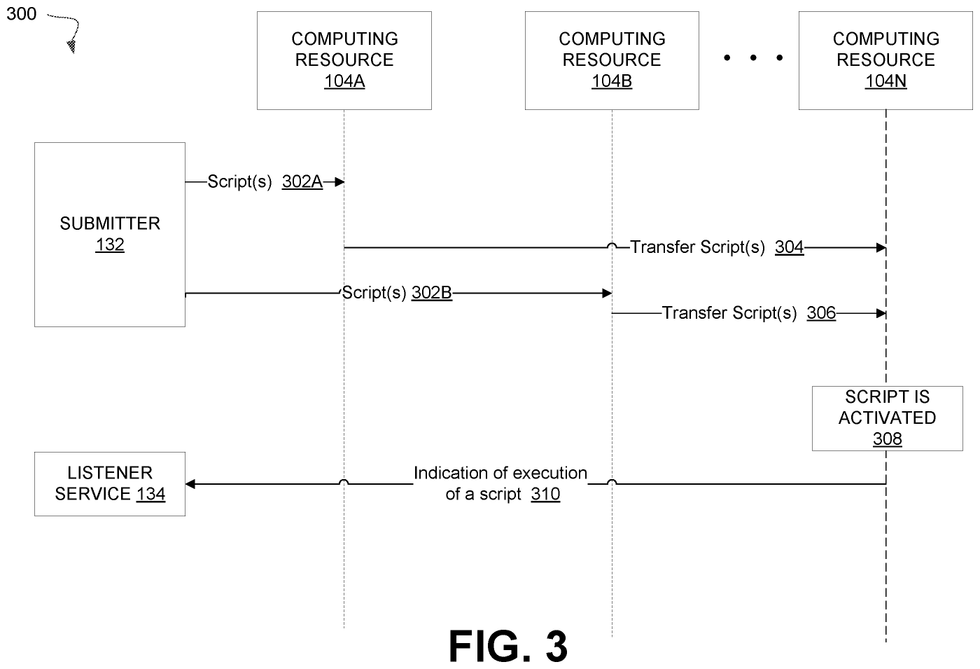

FIG. 3 is a diagram illustrating an implementation of a method 300 executed for detecting a vulnerability in a computing resource using monitored scripts, in accordance with at least one embodiment. Method 300 may be performed by processing logic that includes hardware (e.g., circuitry, dedicated logic, programmable logic, microcode, etc.), software (e.g., instructions run on a processor to perform hardware simulation), or a combination thereof. Method 300 or each of its individual functions, routines, subroutines, or operations may be performed by one or more processors of a computer system (e.g., client device 102A-N, server 130, computing resource 104A-C, and/or cloud computing platform 105 of FIG. 1) implementing the method. In an illustrative example, method 300 may be performed by a single processing thread. Alternatively, method 300 may be performed by two or more processing threads, each thread implementing one or more individual functions, routines, subroutines, or operations of the method. In an illustrative example, the processing threads implementing method 300 may be synchronized (e.g., using semaphores, critical sections, or other thread synchronization mechanisms).

For simplicity of explanation, the methods of this disclosure are depicted and described as a series of acts. However, acts in accordance with this disclosure can occur in various orders and/or concurrently, with other acts not presented and described herein. Furthermore, not all illustrated acts may be needed to implement the methods in accordance with the disclosed subject matter. In addition, it can be appreciated that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

Referring to FIG. 3, the process can begin with submitter 132 submitting, at operation 302A,B, one or more script(s) to computing resources 104A, B. In some embodiments, computing resources 104A-N can be websites, and the one or more scripts can be blind cross-site scripts. For example, cross-site scripting (or blind cross-site scripting) enables a script to route to another computing resource. At operation 304, computing resource 104A routes script(s) to computing resource 104N. At operation 306, computing resource 104B routes script(s) to computing resource 104N. Each time a script is submitted and/or routed (e.g., transferred) to a computing resource 104A-N, the script can be updated to record the transfer. For example, the script can store metadata that keeps a record of the computing resource 104A-N on which it is received. The metadata can also include a timestamp indicating the time at which the script is received by the computing resource 104A-N. The metadata can include additional data to track the transfer lineage of the script.

At operation 308, one of the scripts is activated. That is, computing resource 104N can have a vulnerability that results in the script to begin execution. At operation 310, the activated script sends a signal (e.g., an indication of execution) to the listener service 134. The signal can include the metadata that indicates the lineage of the script. As an illustrative example, computing resource 104N can receive the same script from computing resource 104B (at operation 306) and from computing resource 104A (at operation 304). Thus, when the script is activated, the signal that is sent to listener service 134 (at operation 310) can include an indication of whether the script that was activated was received from computing resource 104A or 104B. This can be useful information to determine whether one of the computing resources 104A,B can have altered the script to cause it to activate on computing resource 104N.

In some embodiments, computing resource 104N may not be known to listener service 134. The signal sent to listener service 134 at operation 310 can include data identifying computing resource 104N. The data can include, for example, machine name, mac address, and/or IP address. The listener service 134 can then store the data from the received signal, e.g., as an event in detection log 112. The listener service 134 can use a combination of the data identifying the computing resource 104N on which the payload executed, the data identifying the payload, and/or the lineage data to the type of computing resource, the location of the computing resource, the time the computing resource began execution of the script, and/or how much of the script was executed. The type of data sent to the listener service 134 can be inherent to the design of the script. In some embodiments, the type of data sent to the listener servicer 134 can be mutated, e.g., by other computing resources 104A,B.

FIG. 4 is a block diagram illustrating an exemplary computer system 400, in accordance with at least one embodiment of the present disclosure. The computer system 400 can correspond to server 130, computing resources 104A-C, cloud computing platform 105, and/or client devices 102A-N in FIG. 1. The machine can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., volatile memory, read-only memory (ROM), flash memory, dynamic random access memory (DRAM) such as synchronous DRAM (SDRAM), double data rate (DDR SDRAM), or DRAM (RDRAM), etc.), a static memory 406 (e.g., non-volatile memory, flash memory, static random access memory (SRAM), etc.), and a data storage device 416, which communicate with each other via a bus 430.

Processor (processing device) 402 represents one or more general-purpose processing devices such as a microprocessor, central processing unit, or the like. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 426 (e.g., for providing a proactive vulnerability detection system by seeding a computing resource with monitored intrusive activity scripts) for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 418 (e.g., a speaker).

The data storage device 416 can include a non-transitory machine-readable storage medium 424 (also computer-readable storage medium) on which is stored one or more sets of instructions 426 (e.g., for providing a proactive vulnerability detection system by seeding a computing resource with monitored intrusive activity scripts) embodying any one or more of the methodologies or functions described herein. The instructions can also reside, completely or at least partially, within the main memory 404 and/or within the processor 402 during execution thereof by the computer system 400, the main memory 404 and the processor 402 also constituting machine-readable storage media. The instructions can further be transmitted or received over a network 420 via the network interface device 408.

In one implementation, the instructions 426 include instructions for providing a proactive vulnerability detection system, e.g., by seeding a computing resource with monitored intrusive activity scripts. While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction(s) between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
generating one or more scripts that are each directed to perform an intrusive activity;
submitting the one or more scripts to a target resource;
responsive to receiving an indication of an execution of a script of the one or more scripts at the target resource, determining that that the target resource is vulnerable to the intrusive activity; and
logging, in a detection log, an event associating the target resource with the intrusive activity.

2. The method of claim 1, wherein the one or more scripts are transferred from the target resource to a second target resource.

3. The method of claim 2, further comprising:
responsive to receiving a second indication of a second execution of the script of the one or more scripts at the second target resource, determining that the second target resource is vulnerable to the intrusive activity.

4. The method of claim 1, wherein responsive to receiving the indication of the execution of the script, the method further comprises:
comparing the indication to known benign activity; and
responsive to determining, based on the comparing, that the indication is benign, updating the event in the detection log to indicate that the intrusive activity is benign.

5. The method of claim 4, further comprising:
updating the one or more scripts by removing the script corresponding to the intrusive activity that is benign.

6. The method of claim 4, further comprising:
generating an additional script comprising an instruction to terminate the execution of the script corresponding to the intrusive activity that is benign at the target resource; and
submitting the additional script to the target resource.

7. The method of claim 1, further comprising:
providing a notification to a user device indicating the target resource that is vulnerable to the intrusive activity.

8. A system comprising:
a memory device; and
a processing device coupled to the memory device, the processing device to perform operations comprising:
generating one or more scripts that are each directed to perform an intrusive activity;
submitting the one or more scripts to a target resource;
responsive to receiving an indication of an execution of a script of the one or more scripts at the target resource, determining that the target resource is vulnerable to the intrusive activity; and
logging, in a detection log, an event associating the target resource with the intrusive activity.

9. The system of claim 8, wherein the one or more scripts are transferred from the target resource to a second target resource, and wherein the operations further comprise:
responsive to receiving a second indication of a second execution of the script of the one or more scripts at the second target resource, determining that the second target resource is vulnerable to the intrusive activity.

10. The system of claim 8, wherein responsive to receiving the indication of the execution of the script, the operations further comprise:
comparing the indication to known benign activity; and
responsive to determining, based on the comparing, that the indication is benign, updating the event in the detection log to indicate that the intrusive activity is benign.

11. The system of claim 10, wherein the operations further comprise:
updating the one or more scripts by removing the script corresponding to the intrusive activity that is benign.

12. The system of claim 10, wherein the operations further comprise:
generating an additional script comprising an instruction to terminate the execution of the script corresponding to the intrusive activity that is benign at the target resource; and
submitting the additional script to the target resource.

13. The system of claim 8, wherein the operations further comprise:
providing a notification to a user device indicating the target resource that is vulnerable to the intrusive activity.

14. A non-transitory computer readable storage medium comprising instructions for a server that, when executed by a processing device, cause the processing device to perform operations comprising:
generating one or more scripts that are each directed to perform an intrusive activity;
submitting the one or more scripts to a target resource;
responsive to receiving an indication of an execution of a script of the one or more scripts at the target resource, determining that the target resource is vulnerable to the intrusive activity; and
logging, in a detection log, an event associating the target resource with the intrusive activity.

15. The non-transitory computer readable storage medium of claim 14, wherein the one or more scripts are transferred from the target resource to a second target resource.

16. The non-transitory computer readable storage medium of claim 15, wherein the operations further comprise:
responsive to receiving a second indication of a second execution of the script of the one or more scripts at the second target resource, determining that the second target resource is vulnerable to the intrusive activity.

17. The non-transitory computer readable storage medium of claim 14, wherein responsive to receiving the indication of the execution of the script, the operations further comprise:
comparing the indication to known benign activity; and
responsive to determining, based on the comparing, that the indication is benign, updating the event in the detection log to indicate that the intrusive activity is benign.

18. The non-transitory computer readable storage medium of claim 17, wherein the operations further comprise:
updating the one or more scripts by removing the script corresponding to the intrusive activity that is benign.

19. The non-transitory computer readable storage medium of claim 17, wherein the operations further comprise:
generating an additional script comprising an instruction to terminate the execution of the script corresponding to the intrusive activity that is benign at the target resource; and
submitting the additional script to the target resource.

20. The non-transitory computer readable storage medium of claim 14, wherein the operations further comprise:
providing a notification to a user device indicating the target resource that is vulnerable to the intrusive activity.
